(19) United States
(12) Patent Application Publication
(10) Pub. No.: US 2009/0063244 A1
(43) Pub. Date: Mar. 5, 2009

(54) TRIANGULATION METHODOLOGIES

(76) Inventor: GIDEON I. GARTNER, New York, NY (US)

Correspondence Address: HOLLAND & KNIGHT LLP, 10 ST. JAMES AVENUE, 11th Floor, BOSTON, MA, 02116-3889, US

(21) Appl. No.: 12/193,444

(22) Filed: Aug. 18, 2008

Related U.S. Application Data
(60) Provisional application No. 60/956,427, filed on Aug. 17, 2007.
(60) Provisional application No. 60/956,429, filed on Aug. 17, 2007.
(60) Provisional application No. 60/956,432, filed on Aug. 17, 2007.
(60) Provisional application No. 60/956,433, filed on Aug. 17, 2007.
(60) Provisional application No. 60/956,546, filed on Aug. 17, 2007.
(60) Provisional application No. 60/956,552, filed on Aug. 17, 2007.
(60) Provisional application No. 60/956,556, filed on Aug. 17, 2007.

(51) Int. Cl. G06Q 10/00; G06Q 50/00

(52) U.S. Cl. 705/9

(57) ABSTRACT

A method for selecting a moderator from a group of moderators, thus defining a selected moderator. An IT-related issue to be addressed is defined. At least one expert is selected from a group of experts, thus defining at least one selected expert. At least one three-way discussion is scheduled between a client, the selected moderator, and the at least one selected expert.

### RELATED APPLICATION(S)

This application claims the benefit of U.S. Provisional Patent Application Ser. No. 60/956,427, entitled SPIDER, filed 17 Aug. 2007, the contents of which are herein incorporated by reference.

This application claims the benefit of U.S. Provisional Patent Application Ser. No. 60/956,429, entitled KNOWLEDGE EXCHANGE PROCESS, filed 17 Aug. 2007, the contents of which are herein incorporated by reference.

This application claims the benefit of U.S. Provisional Patent Application Ser. No. 60/956,432, entitled PROCESS FOR EXPOSING CONFERENCE ATTENDEES TO PRESENTERS, filed 17 Aug. 2007, the contents of which are herein incorporated by reference.

This application claims the benefit of U.S. Provisional Patent Application Ser. No. 60/956,433, entitled SYSTEM FOR ORGANIZING CHARACTERISTICS OF VARIOUS CURRENT IT PRODUCTS, AND FORECASTING SUCCESSOR PRODUCTS, filed 17 Aug. 2007, the contents of which are herein incorporated by reference.

This application claims the benefit of U.S. Provisional Patent Application Ser. No. 60/956,546, entitled CLIENT/EXPERT SWITCH, filed 17 Aug. 2007, the contents of which are herein incorporated by reference.

This application claims the benefit of U.S. Provisional Patent Application Ser. No. 60/956,552, entitled OBJECTIVITY CONTENT FARM/WISDOM CENTER, filed 17 Aug. 2007, the contents of which are herein incorporated by reference.

This application claims the benefit of U.S. Provisional Patent Application Ser. No. 60/956,556, entitled TRIANGULATION, filed 17 Aug. 2007, the contents of which are herein incorporated by reference.

### TECHNICAL FIELD

This disclosure relates to triangulation methodologies and, more particularly, to moderated triangulation methodologies.

### BACKGROUND

Triangulation allows for the aggregation of information from multiple sources (e.g., experts) to educate the recipient of the information with respect to a specific topic. A moderator is often used to facilitate the collection of the information and to assist in the processing of the information. Triangulation as a research and decision-support technique has some similar characteristics to the well known “Delphi” methodology of achieving consensus from a small group of highly informed respondents.

### SUMMARY OF DISCLOSURE

In a first implementation of this disclosure, a method includes selecting a moderator from a group of moderators, thus defining a selected moderator. An IT-related issue to be addressed is defined. At least one expert is selected from a group of experts, thus defining at least one selected expert. At least one three-way discussion is scheduled between a client, the selected moderator, and the at least one selected expert.

One or more of the following features may also be included. The at least one three-way discussion may include at least three three-way discussions. Selecting at least one expert from a group of experts may include allowing the selected moderator to select the at least one selected expert. Selecting at least one expert from a group of experts may include allowing the selected moderator to assist in selecting the at least one selected expert.

Selecting a moderator from a group of moderators may include allowing the client to select the selected moderator. The three-way discussion between the client, the selected moderator, and the at least one selected expert may be effectuated.

The three-way discussion between the client, the selected moderator, and the at least one selected expert may be influenced to form a consensus concerning a solution to the IT-related issue. Influencing the three-way discussion may include allowing the moderator to influence the three-way discussion between the client, the selected moderator, and the at least one selected expert to form a consensus concerning a solution to the IT-related issue to be addressed.

The at least one selected expert may provide an opinion concerning the IT-related issue. The opinion concerning the IT-related issue provided by the at least one selected expert may be challenged. Challenging the opinion concerning the IT-related issue may include allowing the moderator to challenge the opinion concerning the IT-related issue provided by the at least one selected expert.

The at least one three-way discussion between a client, the selected moderator, and the at least one selected expert may be an in-person, three-way discussion. The at least one three-way discussion between a client, the selected moderator, and the at least one selected expert may be a telephone-based, three-way discussion. The at least one three-way discussion between a client, the selected moderator, and the at least one selected expert may be a video-based, three-way discussion.

In another implementation of this disclosure, a method includes selecting a moderator from a group of moderators, thus defining a selected moderator. An IT-related issue to be addressed may be defined. At least one expert may be selected from a group of experts, thus defining at least one selected expert. A plurality of three-way discussions between a client, the selected moderator, and the at least one selected expert may be scheduled. The plurality of three-way discussions between the client, the selected moderator, and the at least one selected expert may be effectuated. The plurality of three-way discussions between the client, the selected moderator, and the at least one selected expert may be influenced to form a consensus concerning a solution to the IT-related issue.

One or more of the following features may also be included. Selecting at least one expert from a group of experts may include allowing the selected moderator to assist in selecting the at least one selected expert. Influencing the plurality of three-way discussions may include allowing the moderator to influence the plurality of three-way discussions between the client, the selected moderator, and the at least one selected expert to form a consensus concerning a solution to the IT-related issue to be addressed. The at least one selected expert may provide an opinion concerning the IT-related issue. The opinion concerning the IT-related issue provided by the at least one selected expert may be challenged.

In another implementation of this disclosure, a method includes selecting a moderator from a group of moderators, thus defining a selected moderator. An IT-related issue to be addressed is defined. The selected moderator is allowed to assist in selecting at least one expert from a group of experts, thus defining at least one selected expert. At least one three-way discussion between a client, the selected moderator, and the at least one selected expert is scheduled. The three-way discussion between the client, the selected moderator, and the at least one selected expert is effectuated.

One or more of the following features may also be included. The three-way discussion between the client, the selected moderator, and the at least one selected expert may be influenced to form a consensus concerning a solution to the IT-related issue. The at least one selected expert may provide an opinion concerning the IT-related issue. The opinion concerning the IT-related issue provided by the at least one selected expert may be challenged.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a triangulation methodology; and

FIG. 2 is a flowchart of the triangulation methodology of FIG. 1.

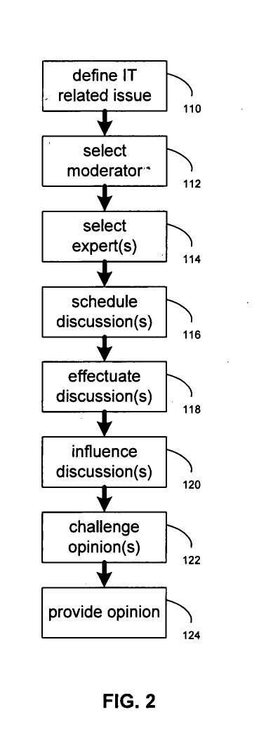

Like reference symbols in the various drawings indicate like elements.

### DETAILED DESCRIPTION OF THE PREFERRED EMBODIMENTS

As is known in the art, triangulation is a consulting business methodology that allows a service provider to obtain, summarize, and deliver expert advice to clients of the service provider. For efficient results, client 10 may triangulate between the positions of various experts (both independent and those employed with firms). Specifically, experts often harbor their own biases and triangulation generally exposes the level of relative expertise and conviction of the various experts, often leading to a convergence of opinion amongst the experts.

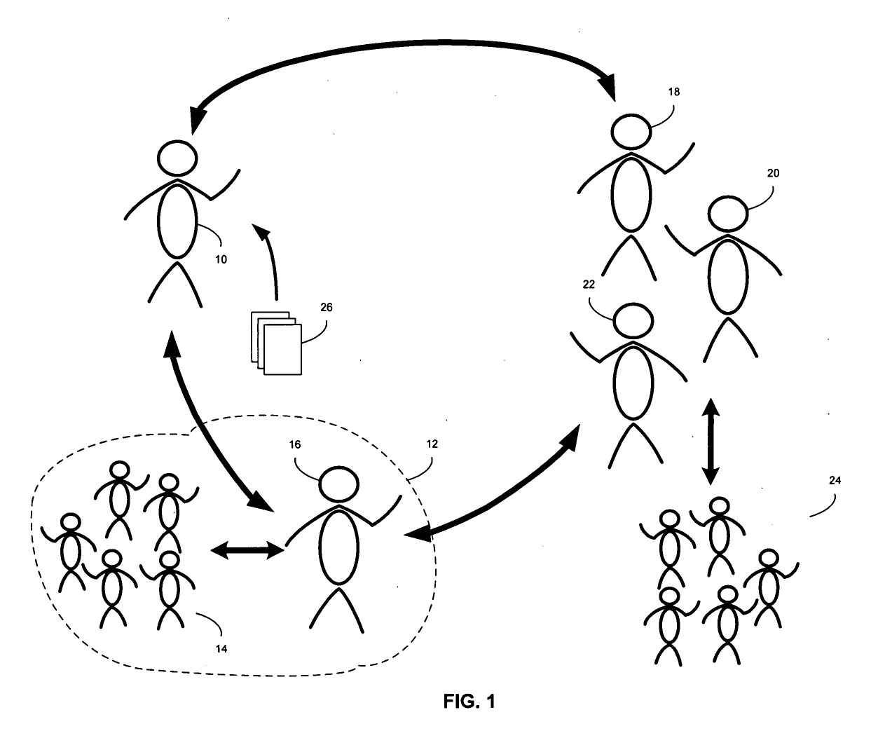

Referring to FIGS. 1 & 2, there is shown one embodiment of such a triangulation method 100. Assume for illustrative purposes that client 10 wishes to obtain advice concerning a specific IT-related topic. For example, assume that client 10 is an IT professional that is planning to upgrade an existing legacy database running on a legacy hardware system to an Oracle database executed on a distributed server network. As this is a complicated project, client 10 may wish to obtain advice concerning e.g. which Oracle database to utilize, which supplemental programs to utilize, and which/how many servers to employ.

Client 10 may contact service provider 12, which may offer triangulation method 100 to client 10. An example of service provider 12 is Responsa LLC of New York, N.Y. Client 10 may define 110 the IT related issue to be addressed via the triangulation method 100 offered by service provider 12. These discussions may continue until there is an agreement between service provider 12 and client 10 concerning what the IT-related issue is. Client 10 may select 112 a moderator from a group of moderators 14 available via service provider 12. Assume for illustrative purposes that when initially contacting service provider 12, client 10 is provided with a group of moderators 14 that each have experience in IT migration issues. Assume further for illustrative purposes that upon reviewing the resumes of each available moderator, client 10 selects 112 moderator 16 from the group of moderators 14 (thus defining a selected moderator), as moderator 16 has specific IT expertise in the area of database migrations.

While method 100 is described above as allowing client 10 to select 110 selected moderator 16, this is for illustrative purposes only and is not intended to be a limitation of this disclosure. Specifically, method 100 may be configured so that service provider 12 selects 110 selected moderator 16 or client 10 and service provider 12 jointly select 110 selected moderator 16.

While method 100 is described above as allowing client 10 to define 110 the IT-related issue prior to selecting 112 the moderator, this is for illustrative purposes only and is not intended to be a limitation of this disclosure, as other configurations are possible and are considered to be within the scope of this disclosure. For example, client 10 may first select 112 a moderator prior to defining 110 the IT-related issue to the selected moderator.

Once moderator 16 is selected 112, at least one expert may be selected 114 from a group of experts 24, thus defining at least one selected expert (e.g., selected experts 18, 20, 22). When selecting 114 at least one expert from group of experts 24, the selected moderator (e.g., selected moderator 16) may be allowed to select 114 the selected expert(s). Further, client 10 may select the expert(s) from group of experts 24. Alternatively still, client 10 and selected expert 16 may collaborate to select 114 the expert(s) from group of experts 24.

Once the moderator is selected 112 from group of moderators 14 and the expert(s) are selected 114 from group of experts 24, at least one three-way discussion may be scheduled 116 between client 10, the selected moderator (e.g., moderator 16), and the selected expert(s) (e.g., experts 18, 20, 22). Multiple (e.g., three) three-way discussions may be scheduled 116 to allow all three parties (e.g., client 10, moderator 16, and experts 18, 20, 22) sufficient time to fully discuss the defined 110 IT-related issue. The specific number of discussions and the spacing between the discussions may vary depending upon the complexity of the IT-related issue and the amount of time available to resolve the IT-related issue.

Once scheduled, the three-way discussion(s) between client 10, selected moderator 16, and selected experts 18, 20, 22 may be effectuated 118. The discussion(s) between client 10, selected moderator 16, and selected experts 18, 20, 22 may be an in-person, three-way discussion(s), telephone-based, three-way discussion(s), and/or video-based, three-way discussion. For example, in the event that client 10, selected moderator 16, and selected experts 18, 20, 22 are all located in the same geographic area (e.g. New York City); client 10, selected moderator 16, and selected experts 18, 20, 22 may meet in person to effectuate 118 the three-way discussion. Further, in the event that client 10, selected moderator 16, and selected experts 18, 20, 22 are not located in the same geographic area but have access to video conferencing equipment; client 10, selected moderator 16, and selected experts 18, 20, 22 may effectuate 118 the three-way discussion(s) via a video-based three-way discussion. Alternatively, in the event that client 10, selected moderator 16, and selected experts 18, 20, 22 are not located in the same geographic area and do not have access to video conferencing equipment; client 10, selected moderator 16, and selected experts 18, 20, 22 may effectuate 118 the three-way discussion(s) via a telephone-based three-way discussion.

Once the three-way discussion(s) are effectuated 118, a free-flowing discussion may take place in which one or more of the experts provides 122 opinion concerning the defined 100 IT-related issue. For illustrative purposes, assume that each of experts 18, 20, 22 provides an opinion concerning the defined 10 IT-related issue. Unfortunately, each of experts 18, 20, 22 may have an opinion that is different from the other opinions (and, therefore, lacking in consensus). Accordingly, the three-way discussion(s) between client 10, selected moderator 16, and selected experts 18, 20, 22 may be influenced 120 to form a consensus concerning a solution to the defined 100 IT-related issue. For example, moderator 16 may influence 120 the three-way discussion(s) between client 10, selected moderator 16, and selected experts 18, 20, 22 to form a consensus concerning a solution to the defined 10 IT-related issue.

One or more of the opinions provided by one or more of the experts (e.g. experts 18, 20, 22) may be challenged 122. For example, moderator 16 may challenge 122 a particular opinion provided by a particular expert if the challenging of such an opinion may result in a consensus being formed concerning the defined 100 IT-related issue. For example, assume that expert 18 and expert 20 each opine that the best solution is to have an older version of the Oracle database executed on a UNIX platform, while expert 22 opines that the best solution is to have the newest version of the Oracle database executed on a Windows platform. Accordingly, moderator 106 may challenge 122 the opinion of expert 22 to see how strongly expert 22 feels concerning the required use of the newest version of the Oracle database on the Windows platform. In the event that the conviction of expert 22 to that particular version of the Oracle database/Windows platform is weak, moderator 16 may attempt to influence 120 the discussion to form a consensus concerning the use of an older version of the Oracle database on a UNIX platform.

These three-way discussions may continue (and the same may be influenced 120 and the individual opinions may be challenged 122) until a consensus is achieved amongst client 10, selected moderator 16, and selected experts 18, 20, 22. At that point in time, moderator 16 may provide 124 a formal opinion 26 to client 10 that represents the consensus achieved between client 10, selected moderator 16, and selected experts 18, 20, 22 with respect to the defined 110 IT-related issue.

While method 100 is defined above as possibly achieving a consensus, this is for illustrative purposes only and is not to be considered a limitation of this disclosure, as other configurations are possible. For example, in the event of divergent opinions (i.e., indicating a lack of consensus), the formal opinion 26 provided to client 10 may simply indicate the differing opinions provided by the expert.

A number of implementations have been described. Nevertheless, it will be understood that various modifications may be made. Accordingly, other implementations are within the scope of the following claims.

What is claimed is:

1. A method comprising:
defining an IT-related issue to be addressed;
selecting a moderator from a group of moderators, thus defining a selected moderator;
selecting at least one expert from a group of experts, thus defining at least one selected expert; and
scheduling at least one three-way discussion between a client, the selected moderator, and the at least one selected expert.

2. The method of claim 1 wherein the at least one three-way discussion includes at least three three-way discussions.

3. The method of claim 1 wherein selecting at least one expert from a group of experts includes:
allowing the selected moderator to select the at least one selected expert.

4. The method of claim 1 wherein selecting at least one expert from a group of experts includes:
allowing the selected moderator to assist in selecting the at least one selected expert.

5. The method of claim 1 wherein selecting a moderator from a group of moderators includes:
allowing the client to select the selected moderator.

6. The method of claim 1 further comprising:
effectuating the three-way discussion between the client, the selected moderator, and the at least one selected expert.

7. The method of claim 1 further comprising:
influencing the three-way discussion between the client, the selected moderator, and the at least one selected expert to form a consensus concerning a solution to the IT-related issue.

8. The method of claim 7 wherein influencing the three-way discussion includes:
allowing the moderator to influence the three-way discussion between the client, the selected moderator, and the at least one selected expert to form a consensus concerning a solution to the IT-related issue.

9. The method of claim 1 wherein the at least one selected expert provides an opinion concerning the IT-related issue, the method further comprising:
challenging the opinion concerning the IT-related issue provided by the at least one selected expert.

10. The method of claim 9 wherein challenging the opinion concerning the IT-related issue includes:
allowing the moderator to challenge the opinion concerning the IT-related issue provided by the at least one selected expert.

11. The method of claim 1 wherein the at least one three-way discussion between a client, the selected moderator, and the at least one selected expert is an in-person, three-way discussion.

12. The method of claim 1 wherein the at least one three-way discussion between a client, the selected moderator, and the at least one selected expert is a telephone-based, three-way discussion.

13. The method of claim 1 wherein the at least one three-way discussion between a client, the selected moderator, and the at least one selected expert is a video-based, three-way discussion.

14. A method comprising:
defining an IT-related issue to be addressed;
selecting a moderator from a group of moderators, thus defining a selected moderator;
selecting at least one expert from a group of experts, thus defining at least one selected expert;
scheduling a plurality of three-way discussions between a client, the selected moderator, and the at least one selected expert;
effectuating the plurality of three-way discussions between the client, the selected moderator, and the at least one selected expert; and
influencing the plurality of three-way discussions between the client, the selected moderator, and the at least one selected expert to form a consensus concerning a solution to the IT-related issue.

15. The method of claim 14 wherein selecting at least one expert from a group of experts includes:
allowing the selected moderator to assist in selecting the at least one selected expert.

16. The method of claim 14 wherein influencing the plurality of three-way discussions includes:
allowing the moderator to influence the plurality of three-way discussions between the client, the selected moderator, and the at least one selected expert to form a consensus concerning a solution to the IT-related issue.

17. The method of claim 1 wherein the at least one selected expert provides an opinion concerning the IT-related issue, the method further comprising:
challenging the opinion concerning the IT-related issue provided by the at least one selected expert.

18. A method comprising:
defining an IT-related issue to be addressed;
selecting a moderator from a group of moderators, thus defining a selected moderator;
allowing the selected moderator to assist in selecting at least one expert from a group of experts, thus defining at least one selected expert;
scheduling at least one three-way discussion between a client, the selected moderator, and the at least one selected expert; and
effectuating the at least one three-way discussion between the client, the selected moderator, and the at least one selected expert.

19. The method of claim 18 further comprising:
influencing the at least one three-way discussion between the client, the selected moderator, and the at least one selected expert to form a consensus concerning a solution to the IT-related issue.

20. The method of claim 18 wherein the at least one selected expert provides an opinion concerning the IT-related issue, the method further comprising:
challenging the opinion concerning the IT-related issue provided by the at least one selected expert.
